(19) United States
(12) Patent Application Publication
(10) Pub. No.: US 2019/0253806 A1
(43) Pub. Date: Aug. 15, 2019

(54) PORTED TWEETER

(71) Applicant: Alexander B. Ralph, WInter Garden, FL (US)

(72) Inventor: Alexander B. Ralph, WInter Garden, FL (US)

(21) Appl. No.: 16/112,422

(22) Filed: Aug. 24, 2018

Related U.S. Application Data
(60) Provisional application No. 62/631,066, filed on Feb. 15, 2018.

(51) Int. Cl. H04R 9/06; H04R 7/18; H04R 7/12; H04R 1/28; H04R 9/02

(52) U.S. Cl. CPC H04R 9/06; H04R 7/18; H04R 2400/11; H04R 1/2811; H04R 9/025; H04R 7/127

(57) ABSTRACT

A ported tweeter includes a high energy magnet that is positioned between a top plate and a bottom plate. A voice coil former having a voice coil wrapped thereabout is positioned along the top plate. A frame is secured to the magnet and includes a central opening for receiving a diaphragm. A diaphragm support member that is positioned along the top plate and extends through the former at a location within the diaphragm. The diaphragm includes a centrally located aperture creating an opening that is between 0.14 to 0.25 of the surface area of the diaphragm.

### CROSS-REFERENCE TO RELATED APPLICATIONS

This application claims the benefit of U.S. Application Ser. No. 62/631,066 filed on Feb. 15, 2018, the contents of which are incorporated herein by reference.

### TECHNICAL FIELD

The present invention relates generally to sound producing devices, and more particularly to a tweeter having an air port for improving the performance, frequency range, midrange output level and sound quality of the speaker.

### BACKGROUND

The statements in this section merely provide background information related to the present disclosure and may not constitute prior art.

Tweeters are a type of speaker that is designed to reproduce high frequencies. As is known to those of skill in the art, the volume of air behind a tweeter diaphragm helps determine the frequency and Q factor at resonance, as the air acts as a spring against the diaphragm. For this reason, the area between the electromagnet and diaphragm of a traditional tweeter is sealed, to prevent the air from escaping during operation and deteriorating the sound of the speaker. Although this arrangement has functioned well for many years, the small shape and size of tweeters have made it difficult to adjust or increase the air volume within the sealed space to improve the sound quality.

The present invention directed to a ported tweeter differs from the conventional art in a number of aspects. The manner by which will become more apparent in the description which follows, particularly when read in conjunction with the accompanying drawings.

### SUMMARY OF THE INVENTION

The present invention is directed to a ported tweeter. One embodiment of the present invention can include a high energy magnet that is positioned between a top plate and a bottom plate. A voice coil former having a voice coil wrapped thereabout is positioned along the top plate. The tweeter also includes a frame having a central opening for receiving a diaphragm, and a diaphragm support member that is positioned along the top plate and extends through the former at a location within the diaphragm. The diaphragm can include a centrally located aperture creating an opening that is between 0.14 to 0.25 of the surface area of the diaphragm and functioning to provide increased sound performance.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a ported tweeter that is useful for understanding the inventive concepts disclosed herein.

FIG. 2 is an exploded parts view of a ported tweeter, in accordance with one embodiment of the invention.

FIG. 3 is a perspective view of a partially assembled ported tweeter, in accordance with one embodiment of the invention.

FIG. 4 is a comparative distortion response diagram of the ported tweeter of FIG. 3.

FIG. 5 is a comparative Sound Pressure Level (SPL) response diagram of the ported tweeter of FIG. 3.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As will be described below, the inventor of the presently claimed invention has discovered that by positioning an aperture within the diaphragm of a tweeter, it is possible to allow a set volume of air to enter and escape the traditionally sealed space between the speaker diaphragm and magnet. This acts as a Helmholtz resonator that drastically improves the sound quality, midrange output level and range of a speaker when compared to a traditional speaker having the same shape and size. More specifically, the inclusion of such an aperture allows the diaphragm to move less over a range of frequencies, which reduces the distortion of the speaker, and extends the mid-range sound quality of the speaker significantly.

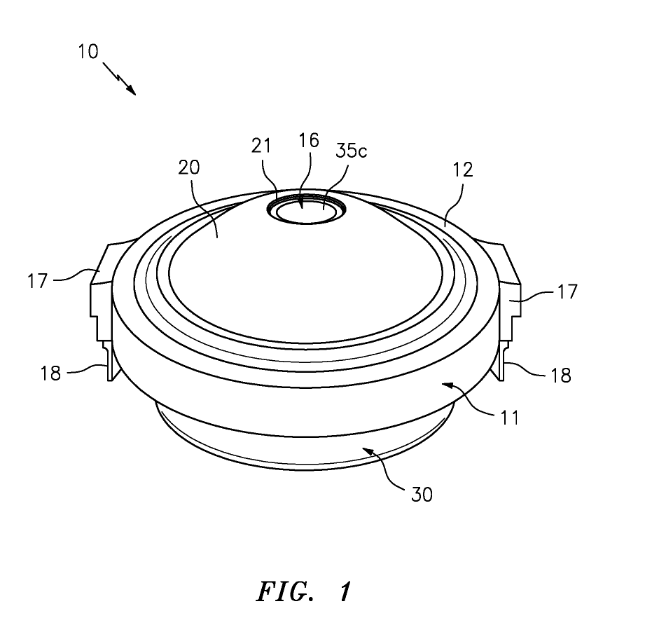

One embodiment of a ported tweeter 10 is provided throughout the drawings to aid in understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

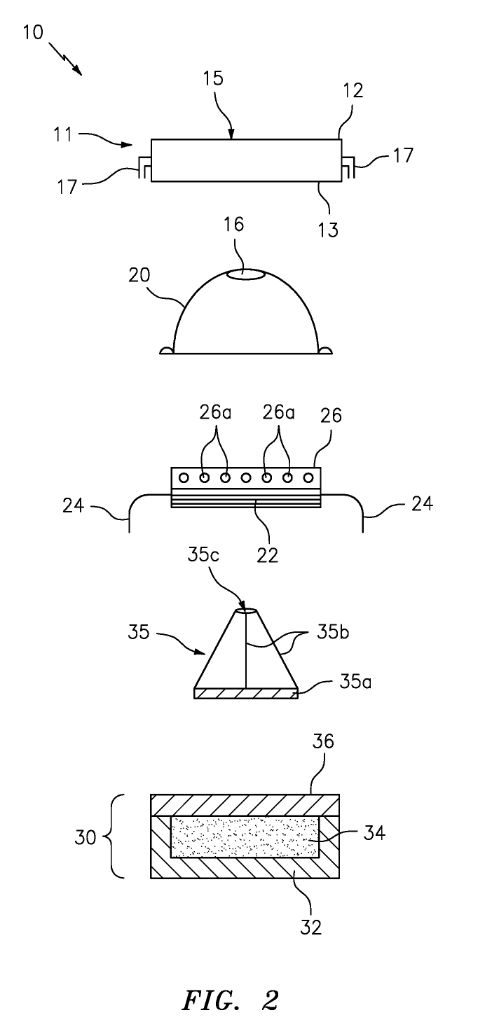

FIGS. 1 and 2 are a top view and an exploded parts view of a ported tweeter 10, in accordance with the teachings of the invention. As shown, the tweeter can include a circular frame 11 that is constructed from plastic, or other non-magnetic material. The frame can include a top surface 12, a bottom surface 13, a central opening 15 and a pair of channels 17 through which speaker terminals 18 can extend. The frame can include a shape and size that is complementary to the shape and size of the below described magnetic assembly so as to be secured thereto.

The tweeter can also include a dome-shaped diaphragm 20 that is constructed of woven fabric, thin metal or other such material. An aperture 16 can be positioned along the top portion of the diaphragm. The aperture including a specific shape and size that function to allow a specific amount of air to enter and exit the speaker body during device operation.

In one embodiment, the tweeter can include a voice coil 22 having a pair of leads 24 extending therefrom. The voice coil can be constructed from a thin piece of electrically conductive wire that is wrapped around a circular shaped voice coil former 26. In the preferred embodiment, the former 26 can include a plurality of holes 26a and can be constructed from low magnetic permeability material such as aluminum or stainless steel, for example.

The tweeter can also include a magnet assembly 30 having a bottom plate 32 that is constructed from a high permeability material, a high energy magnet 34 such as a neodymium or a ferrite magnet, for example, and a top plate 36 which is also formed of a high permeability material.

In the preferred embodiment, the tweeter 10 can also include a diaphragm support member 35 that is constructed from a lightweight non-magnetic material such as plastic, for example. The support member can include a tapered shape having a hollow circular-shaped bottom portion 35a, a plurality of elongated arms 35b and a hollow circular-shaped upper portion 35c. The support member can be positioned inside the diaphragm and can function to limit the movement of the diaphragm 20. Of course, the support member can include any number of other shapes sizes and construction materials.

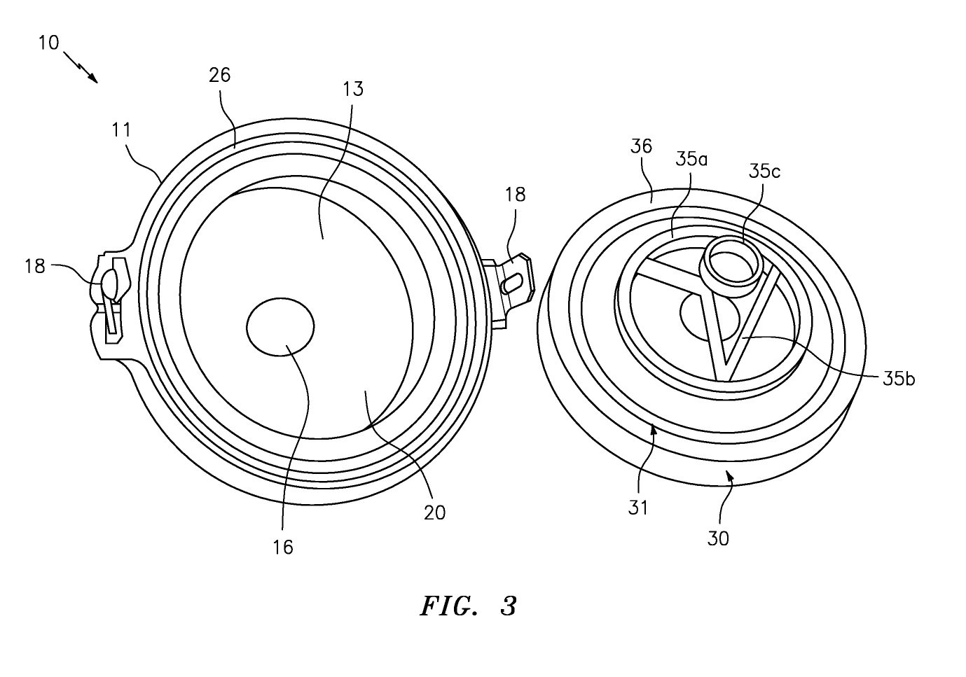

FIG. 3 illustrates one embodiment of a partially assembled ported tweeter that is separated into top and bottom halves. As shown, the diaphragm 20, former 26 and coil 22 can be positioned within the frame 11, and the coil leads can be routed through the channels 17 and connected to the terminals 18. Likewise, the bottom portion 35a of the support member can be positioned along the top plate 36 preferably inside the diameter formed by the voice coil gap 31. When the top and bottom sections are assembled, as shown in FIG. 1, the elongated arms 35b are positioned within the former 26 and the upper portion 35c is sealed within the aperture 16 of the diaphragm 20 via a gasket 21.

In operation, current applied to the voice coil 22 through the terminals 18 causes the coil to move relative to the magnet 34 in a manner known in the art. The coil former 26 moves with the coil 22 and applies varying pressures to the diaphragm 20 to produce the desired audio output. During this time, the aperture 16 and the opening formed by the upper portion 35c allow a specific amount of air to enter the diaphragm.

Through extensive research and testing, the inventor has discovered that providing a single aperture at the front center portion of the diaphragm reduces distortion of the diaphragm and allows the diaphragm to move in a pure linear motion. Stated differently, the aperture which is placed in-line with the movement of the diaphragm allows air to enter and leave the (typically sealed) speaker environment so as to reduce the turbulence within the speaker system that would otherwise occur. By reducing the turbulence, the diaphragm functions in a purely linear motion to create the sound waves at a frequency and clarity not previously possible. Moreover, the inventor has discovered that when the aperture has a size of between 0.14 to 0.25 of the surface area of the diaphragm 20, the tweeter 10 reduces port compression and provides enhanced sound characteristics at high frequencies, which is a critical feature.

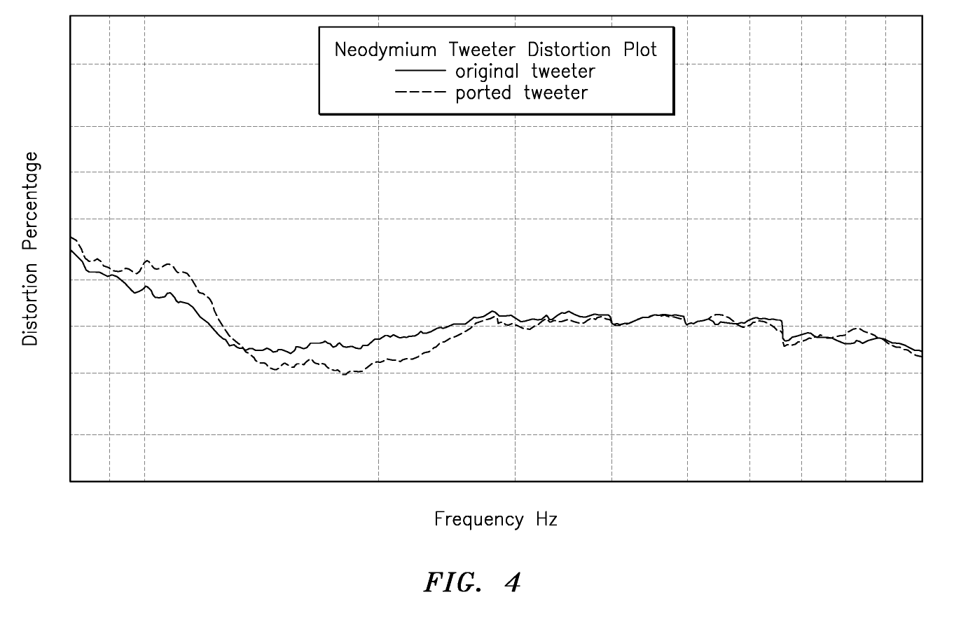

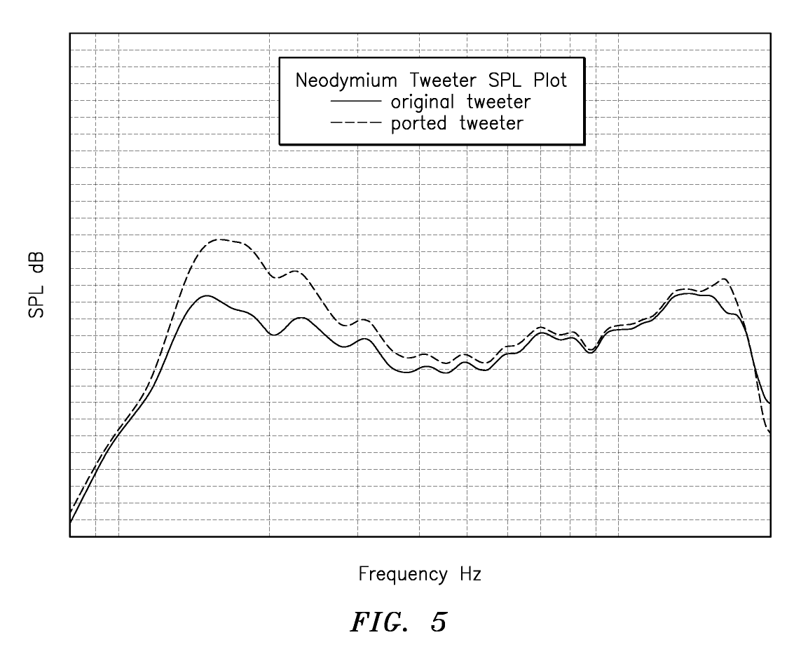

As evidenced by the test results shown in FIGS. 4 and 5, the ported tweeter 10 described above achieves significantly better sound quality than other non-ported tweeters having identical shapes, sizes and at the same power levels. To this end, the specific flow of air from the aperture 16 causes the tweeter diaphragm to move less, which lowers the distortions when the same power is applied to the speaker. This means the ported tweeter 10 is capable of outputting twice the power of a conventional non-ported tweeter across a range of frequencies ranging from 2,000 Hz to 20,000 Hz, thereby extending the mid-range response without having to add additional structure.

As described herein, one or more elements of the ported tweeter 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A ported tweeter, comprising:
a frame having a central opening;
a diaphragm that is positioned within the central opening of the frame;
a high energy magnet;
a top plate that is positioned along a first side of the high energy magnet;
a voice coil former that is positioned along the top plate;
a voice coil that is positioned about an exterior surface of the voice coil former;
a diaphragm support member that is positioned along the top plate and extends through an interior portion of the voice coil former; and
an aperture that is positioned along a distal end of the diaphragm and is configured to allow air to engage the top plate.

2. The tweeter of claim 1, wherein the diaphragm support member is constructed from a non-magnetic material and includes a tapered shape.

3. The tweeter of claim 2, wherein the diaphragm support member comprises:
a hollow circular-shaped bottom portion having a first diameter;
a hollow circular-shaped top portion having a second diameter; and
a plurality of elongated arms connecting the top portion and the bottom portion,
wherein the first diameter is greater than the second diameter.

4. The tweeter of claim 3, wherein the second diameter is complementary to a diameter of the aperture positioned along the distal end of the diaphragm.

5. The tweeter of claim 1, wherein the high energy magnet comprises a neodymium magnet.

6. The tweeter of claim 1, wherein the high energy magnet comprises a ferrite magnet.

7. The tweeter of claim 1, further comprising a pair of channels each having a speaker terminal extending outward from the frame.

8. The tweeter of claim 1, further comprising:
a bottom plate that is connected to a second side of the magnet,
wherein the top plate and the bottom plate are constructed from a high permeability material.
